(19) United States
(12) Patent Application Publication
(10) Pub. No.: US 2026/0023053 A1
(43) Pub. Date: Jan. 22, 2026

(54) SYSTEMS AND METHODS FOR TWO-DIMENSIONAL CHROMATOGRAPHY

(71) Applicant: AGILENT TECHNOLOGIES, INC., Santa Clara, CA (US)

(72) Inventor: Sheher Banu Mohsin, Santa Clara, CA (US)

(21) Appl. No.: 18/776,864

(22) Filed: Jul. 18, 2024

(51) Int. Cl. G01N 30/46; B01D 15/16; B01D 15/18; B01D 15/40; G01N 30/02; G01N 30/14; G01N 30/72; G01N 30/86; G01N 30/88

(52) U.S. Cl. CPC G01N 30/468; B01D 15/163; B01D 15/1878; B01D 15/40; G01N 30/14; G01N 30/7233; G01N 30/8624; G01N 30/88; G01N 2030/027; G01N 2030/8813

(57) ABSTRACT

Systems for performing two-dimensional chromatography are disclosed. The system includes a first switching valve fluidly coupled to a first separation column. The system includes a second switching valve coupled to a second separation column. The second switching valve is fluidly coupled to the first switching valve. The system includes an input/output valve in fluid communication with the first switching valve and the second switching valve that is configured to direct one or more mobile phases to the first switching valve. The system includes a sampling valve fluidly coupled to the first switching valve that includes at least one fraction capturing device. Methods of separating compounds using the systems are disclosed. Methods of retrofitting existing two-dimensional chromatography systems are also disclosed.

### FIELD OF TECHNOLOGY

Aspects and embodiments disclosed herein are generally related to multidimensional chromatography systems and methods for orthogonal separation and analysis of mixtures of compounds.

### SUMMARY

In accordance with an aspect, there is provided a two-dimensional chromatography system. The system may include a first switching valve fluidly coupled to a first separation column. The system may include a second switching valve coupled to a second separation column. The second switching valve may be fluidly coupled to the first switching valve. The system further may include an input/output valve in fluid communication with the first switching valve and the second switching valve. The input/output valve may be configured to direct one or more mobile phases to the first switching valve. The system additionally may include a sampling valve fluidly coupled to the first switching valve and may include at least one fraction capturing device.

In some embodiments, the input/output valve may be fluidly coupled to a downstream analytical instrument. For example, the downstream analytical instrument may be a type of physical characterization analytical instrument, e.g., evaporative light scattering detection (ELSD). In further embodiments, the downstream analytical instrument may include chemical characterization, e.g., spectroscopy, e.g., ultraviolet, visible, or fluorescence spectroscopy, or mass spectrometry.

In some embodiments, the first switching valve may be configured to direct the one or more mobile phases to the sampling valve without passing through the first separation column, e.g., operation in a bypass mode.

In some embodiments, the input/output valve may be configured to direct the one or more mobile phases to a sampler device storing a sample, e.g., an autosampler. From the sampling device, the first switching valve may be configured to direct the one or more mobile phases having the sample through the first separation column.

In further embodiments, the first switching valve may be configured to direct fractions from the first separation column as one or more heartcuts to the sampling valve. The sampling valve may be disposed to store the one or more heartcuts on the at least one fraction capturing device. The at least one fraction capturing device may include a cartridge, e.g., a solid-phase extraction cartridge, or one or more columns that may include a medium for supporting the one or more heartcuts.

In further embodiments, the sampling valve may be configured to direct at least one mobile phase from the input/output valve to elute the one or more heartcuts from the at least one fraction capturing device. The sampling valve may be further configured to direct the elutions of the one or more heartcuts from the at least one fraction capturing device to the second switching valve. In some embodiments, the second switching valve may be configured to direct the elutions of the one or more heartcuts from the at least one fraction capturing device to the second separation column. In further embodiments, the second switching valve may be configured to direct fractions from the second separation column to the input/output valve.

In some embodiments, the second switching valve may be configured to direct the elutions of the one or more heartcuts from the at least one cartridge to the input/output valve.

In some embodiments, the sampling valve further may be configured to bypass the at least one fraction capturing device.

In some embodiments, the first switching valve may be associated with a first chromatographic separation system including supercritical fluid chromatography (SFC). In this configuration, the second switching valve may be associated with a second chromatographic separation system including high pressure liquid chromatography (HPLC).

In some embodiments, the first switching valve may be associated with a first chromatographic separation system including HPLC. In this configuration, the second switching valve may be associated with a second chromatographic separation system including SFC.

In accordance with an aspect, there is provided a method of separating one or more fractions from a sample. The method may include directing one or more mobile phases carrying a sample from an input/output valve to a first separation column. The method may include directing one or more fractions from the first separation column to a sampling valve. The sampling valve may include at least one fraction capturing device configured to store at least one fraction of the one or more fractions per at least one fraction capturing device. The method further may include eluting the one or more fractions from the at least one fraction capturing device. The method may include directing each of the one or more eluted fractions to a second separation column. The method additionally may include separating one or more compounds within each of the one or more eluted fractions using the second separation column.

In some embodiments, the first separation column may be associated with a first chromatographic separation system including SFC or HPLC. In some embodiments, the second separation column may be associated with a second chromatographic separation system including SFC or HPLC. In a specific embodiment, the first chromatographic separation system may include SFC and the second chromatographic separation system may include HPLC. In a particular embodiment, the first chromatographic separation system may include HPLC and the second chromatographic separation system may include SFC.

In accordance with an aspect, there is provided a method of retrofitting a two-dimensional chromatography system. The two-dimensional chromatography system to be retrofitted may include a first chromatographic separation system including a first separation column fluidly coupled to a second chromatographic separation system including a second separation column. The method may include fluidly coupling an input/output valve to a first switching valve of the first chromatographic separation system and a second switching valve of the second chromatographic separation system. The coupling of the input/output valve to the first switching valve and the second switching valve may be performed such that one or more mobile phases can flow from the input/output valve to the first switching valve to the second switching valve. The method may include fluidly coupling a sampling valve between the first switching valve and the second switching valve. The sampling valve may include at least one fraction capturing device configured to collect one or more fractions of a sample passed through the first separation column.

### BRIEF DESCRIPTION OF THE DRAWINGS

The accompanying drawings are not drawn to scale. In the drawings, each identical or nearly identical component that is illustrated in the various figures may be represented by a like numeral. For purposes of clarity, not every component may be labeled in every drawing. In the drawings:

FIG. 1 illustrates a chromatogram of the lipidome;

FIG. 2 illustrates a schematic of a flow path through a 2D chromatography system with separation of the sample on a first separation column, according to an embodiment;

FIG. 3 illustrates a schematic of a flow path through the 2D chromatography system of FIG. 2 with separation of a heart cut from the first separation column on a second separation column, according to an embodiment;

FIG. 4 illustrates a chromatogram illustrating the capturing and detection of two different fractions onto two separate solid-phase extraction cartridges from a SFC first dimension separation; and

FIGS. 5A-5B illustrate chromatograms of the first and second heart cuts from the total ion chromatogram shown in FIG. 8 separated using UHPLC. FIG. 5A illustrates UHPLC separation of the first heart cut and FIG. 5B illustrates UHPLC separation of the second heart cut.

### DETAILED DESCRIPTION

Chromatography is widely used in separation and analysis of mixtures of compounds. Due to limitations in peak capacity of one-dimensional chromatography, multi-dimensional chromatography systems with significantly increased peak capacity have been devised for the analysis of complex samples. Two-dimensional (2D) chromatographic techniques have become popular especially in the analysis of complex mixtures such as those relevant to the pharmaceutical industry. As compared to one-dimensional (1D) chromatography, 2D chromatographic techniques have higher selectivity and resolving power assuming the retention mechanisms are complementary. The maximum peak capacity in a two-dimensional separation system is achieved when the selectivity of the individual separations are independent, i.e., orthogonal, such that components which are poorly resolved in the first dimension may be substantially completely resolved in the second dimension. If orthogonal separation mechanisms are used in the two dimensions, the theoretical peak capacity of the system is the product of the individual peak capacities.

However, some restrictions exist for 2D chromatography in terms of sensitivity and solvent compatibility. For example, the mobile phase that is carried over from the first dimension often creates interference with the second dimension, thus limiting the separation capability of the second dimension. The incompatibility of solvents used in the first and second dimensions can cause severe band dispersion or broadening and peak deterioration, thus posing challenges for the design of fluid handling interfaces.

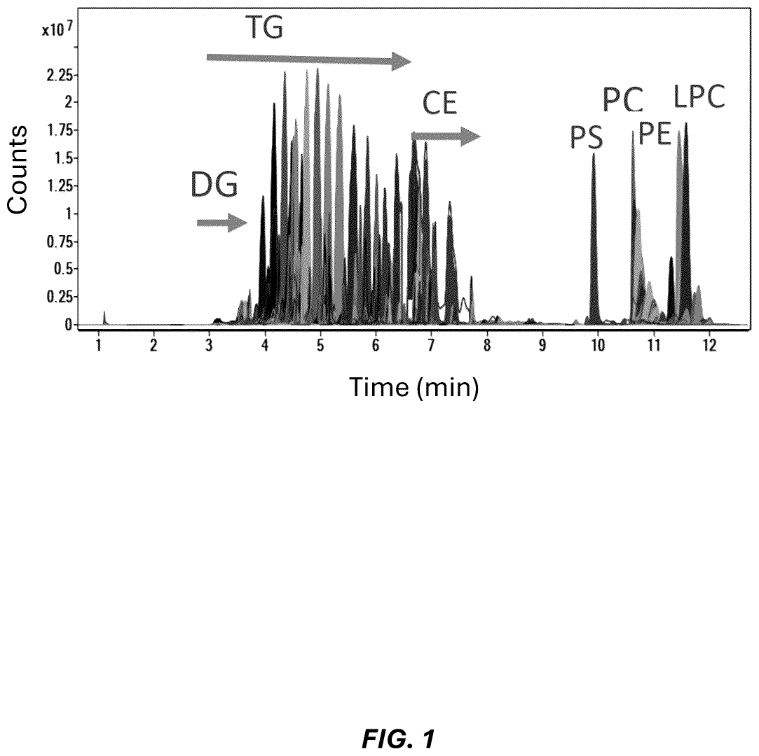

The lipidome, used herein to describe the totality of lipids in cells, is very complex with the lipids ranging in polarity from non-polar to very polar. An example of a chromatogram of the lipidome using SFC is illustrated in FIG. 1. As illustrated, SFC provides good separation between the different classes of lipids, e.g., diglycerides (DG), triglycerides (TG), cholesterol esters (CE), phosphatidylserine (PS), phosphatidylcholie (PC), phosphatidylethanolamine (PE), and lysophosphatidylcholine (LPC), with little overlap between classes. Profiling lipidomics requires separation and identification of hundreds of lipids, including isomers, preferably in a single analytical run. Significant advances have been made for the separation of lipid isomers and isobars using different chromatographic techniques such as GC with derivatization, reverse phase HPLC, normal phase HPLC, HILIC or SFC. However, as observed in FIG. 1, lipid separation is still a significant challenge because of structural similarity between lipid species and the complex nature and diversity of lipids especially in biological extracts. Normal phase and reverse phase techniques have been widely used to separate lipids. Each technique has its advantages. Reverse phase HPLC is very efficient at separating lipids, sometimes even isomeric species, but lipid classes can overlap during elution making annotation challenging.

Disclosed herein are systems and methods for performing 2-D chromatography, e.g., with orthogonal separation techniques as the first dimension and second dimension. The orthogonal separation techniques can include SFC in either the first dimension or second dimension and HPLC, e.g., UHPLC, in either the first dimension or second dimension. The combination of two orthogonal separation techniques, SFC and HPLC, has the potential of doubling peak capacity when used in a 2-D arrangement with a series of valves connecting the two orthogonal separation techniques. More analytes can be separated and identified than in a 1-D measurement. For the analysis of lipids. As a non-limiting example, SFC can be used to perform lipid class separation and HPLC in the second dimension can be used to separate compounds within each class of lipid for a more thorough investigation of the lipidome. The systems disclosed herein can be used for chiral separations with SFC followed by HPLC separation in the second dimension. The systems disclosed herein can further be used for HPLC separation in the first dimension followed by SFC separation in the second dimension.

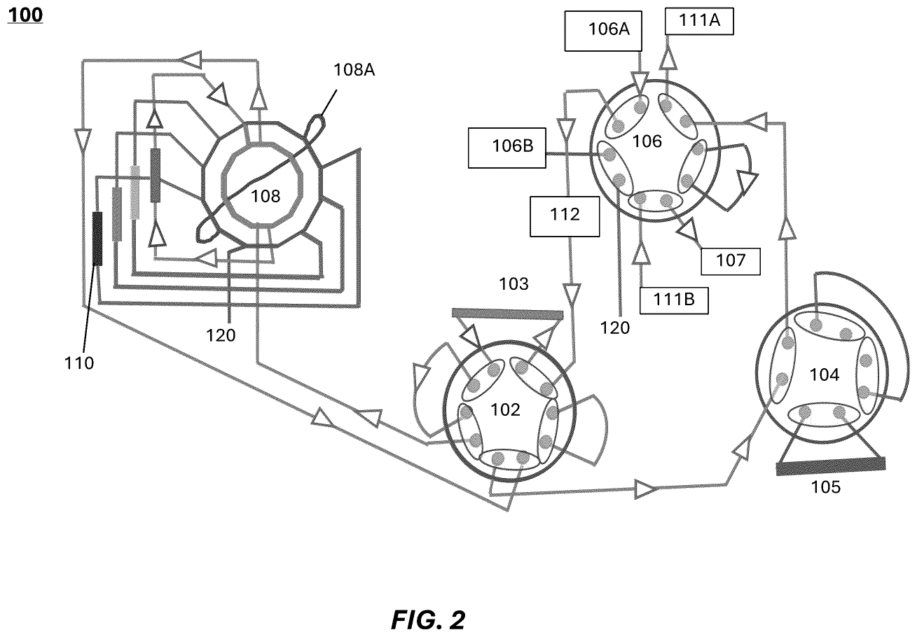

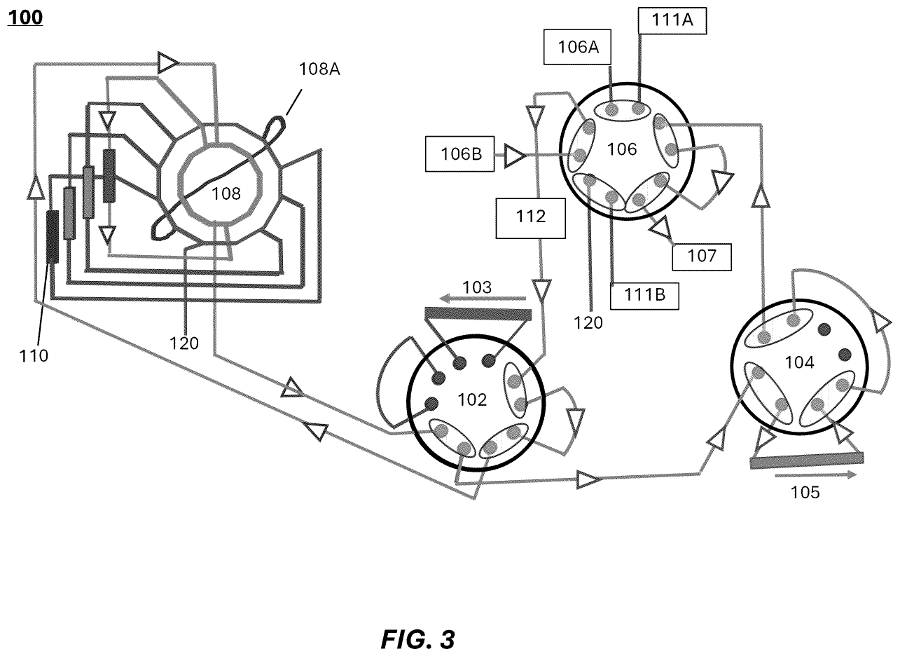

An embodiment of a 2-D chromatography system is illustrated in FIGS. 2 and 3. With reference to FIGS. 2 and 3, system 100 includes a first switching valve 102 fluidly coupled to a first separation column 103 and a second switching valve 104 coupled to a second separation column 105. The first switching valve 102 is fluidly coupled to the second switching valve 104. The first switching valve 102 and the second switching valve 104 can be any suitable type of valve that has multiple ports, e.g., inlets and outlets, to facilitate a plurality of fluid connections and is compatible with chromatographic mobile phases and samples having varied chemical compositions. For example, the first switching valve 102 and the second switching valve 104 can be multi-port switching or rotary valves rated to pressures of about 1200 bar. The first separation column 103 and the second separation column 105 can be connected to the first switching valve 102 and the second switching valve 104, respectively, such that one or more mobile phases directed into a port on the respective valve can flow through the separation columns and back into the respective valve to be directed elsewhere in the system 100. The first separation column 103 and the second separation column 105 can be any column that is suitable for the mobile phase, sample, and type of separation desired. This disclosure is in no way limited by the choice of column, mobile phase composition, and type of sample to be separated and analyzed.

With continued reference to FIGS. 2 and 3, the system 100 includes an input/output valve 106 that is in fluid communication with both of the first switching valve 102 and the second switching valve 104. The input/output valve 106 is connected to various fluid handling devices, such as mobile phase sources 106A, 106B for the one or more mobile phases, fluid splitters 111A, 11B, and waste outputs 120. The input/output valve 106 includes a connection to a downstream analytical instrument 107 that is used to analyze a sample that has passed through the first separation column 103, second separation column 105, or any other sample processing component of system 100. For example, the downstream analytical instrument may be a type of physical characterization analytical instrument, e.g., evaporative light scattering detection (ELSD). In further embodiments, the downstream analytical instrument may include chemical characterization, e.g., spectroscopy, e.g., ultraviolet, visible, or fluorescence spectroscopy, or one or more types of mass spectrometry. This disclosure is in no way limited by the selection of the downstream analytical instrument 107 connected to the input/output valve 106.

The input/output valve 106 is configured to direct one or more mobile phases to the first switching valve though a fluidic connection. The input/output valve 106 is further configured to direct the one or more mobile phases to a sampler device 112 storing a sample. The sampler device 112 is disposed between the input/output valve 106 and the first switching valve 102 such that the one or more mobile phases from the mobile phase sources 106A, 106B are directed through the sampler device 112 to carry the sample into the first switching valve 102. The sampler device 112 can be an autosampler or a port that permits manual introduction of a sample, e.g., a septum or the like. Once the one or more mobile phases and the sample are directed into the first switching valve 102, the first switching valve 102 can be set such that the one or more mobile phases and the sample enter the first separation column 103 as illustrated by the arrow shown at the first separation column 103. Alternatively, the first switching valve 102 can be set such that the one or more mobile phases, with or without the sample, bypass, i.e., do not pass through, the first separation column 103. The first separation column 103 separates the components in the sample according to interactions with the stationary phase held within the first separation column 103. Each of the separated components of the sample can be individually resolved and/or further analyzed after elution off the first separation column 103 using the one or more mobile phases associated with the first separation.

With continued reference to FIGS. 2 and 3, system 100 includes a sampling valve 108 that is fluidly coupled to the first switching valve 102. The sampling valve 108 includes at least one fraction capturing device 110 that is fluidly coupled to the fluid connection from the first switching valve 102. In operation, a position of the sampling valve 108 can be set such that one or more fractions from the first separation column 103 can be stored on one or more of the at least one fraction capturing device 110. As illustrated in FIG. 2, there are four fraction capturing devices 110 at different positions on the sampling valve 108. The sampling valve 108 can be set, e.g., have its rotor position set, such that a fraction from the first separation column 103 can be stored in one of the four fraction capturing devices 110. The storing of fractions from a sample on a fraction capturing device is termed herein as heart cutting and is often performed to isolate a portion of a sample as a function of time. As disclosed herein, the one or more heart cuts from the first separation column 103 can be stored on the at least one fraction capturing device 110 for later analysis, e.g., using a second dimension of chromatography. The sampling valve 108 directs at least one mobile phase from the input/output valve 106 to elute the one or more heart cuts from the at least one fraction capturing device 110 when the desired analysis is to be performed. The at least one fraction capturing device 110 can be any suitable device used to hold a sample, such as a cartridge, e.g., a solid-phase extraction cartridge, or one or more columns that may include a medium for supporting the one or more heart cuts from the first separation column 103. This disclosure is in no way limited by the selection of the at least one fraction capturing device 110 and any physical or chemical features associated therein.

In some configurations, i.e., when no heart cuts are being stored from the first separation column 103, the sampling valve 108 can be set to pass the one or more mobile phases, and optionally a sample, though its bypass line 108A, e.g., without storing any part of the sample or a fraction thereof on the at least one fraction capturing devices 110. In this configuration, the one or more mobile phases, and optionally a sample, can be directed to the waste exit 120 of the sampling valve 108, back to the first switching valve 102, or onto another component in system 100.

With continued reference to FIGS. 2 and 3, the sampling valve 108 is configured to direct elutions of the one or more heart cuts from the at least one fraction capturing device 110 to the second switching valve 104. As illustrated in FIG. 2, the second switching valve 104 includes a fluidly connected second separation column 105 and fluid connections to the input/output valve 106. In some configurations, such as that illustrated in FIG. 3, the second switching valve 104 can be set to direct the elutions of the one or more heart cuts to the second separation column 105 for further analysis as indicated by the arrow at second separation column 105. The second separation column 105 can resolve the individual components of each of the eluted one or more heart cuts from the first separation column 103. Following separation in the second separation column 105, the second switching valve 104 is configured to direct one or more fractions from the second separation column 105 to the input/output valve 106. For example, the one or more fractions from the second separation column 105 can be directed to the input/output valve 106 to be analyzed using the downstream analytical instrument 107 connected to the input/output valve 106. Further, the one or more fractions from the second separation column 105 can be directed to the input/output valve 106 to be sent to waste line 120, e.g., following analysis or during maintenance. In some cases, if no separation of the elutions of the one or more heart cuts from the at least one cartridge 110, e.g., separation using the second separation column 105, the second switching valve 104 can direct the elutions of the one or more heart cuts from the at least one cartridge 110 to the input/output valve 106, i.e., without passing through the second separation column 105, i.e., a bypass.

The system 100 illustrated in FIGS. 2 and 3 can be used with the same separation technique for the first dimension and the second dimension. For example, in some configurations, the first switching valve 102 is associated with a first chromatographic separation system including SFC and the second switching valve 104 is associated with a second chromatographic separation system including SFC. In a different configuration, the first switching valve 102 is associated with a first chromatographic separation system including HPLC, e.g., UHPLC, and the second switching valve 104 is associated with a second chromatographic separation system including HPLC, e.g., UHPLC. In other configurations, the systems illustrated in FIGS. 2 and 3 can be used with orthogonal separation techniques for the first dimension and the second dimension. In an example, the first switching valve 102 is associated with a first chromatographic separation system including SFC and the second switching valve 104 is associated with a second chromatographic separation system including HPLC, e.g., UHPLC. In another example, the first switching valve 102 is associated with a first chromatographic separation system including HPLC, e.g., UHPLC, and the second switching valve 104 is associated with a second chromatographic separation system including SFC. The system 100 illustrated in FIGS. 2 and 3 can also be used for single dimension experiments. For example, the system 100 can be used for SFC or HPLC, e.g., UHPLC, in the first dimension without a second dimension experiment. In further embodiments, the system 100 can be used for direct sample injection with no separation dimension. This disclosure is in no way limited by the dimensionality of the system or in the separation techniques utilized in any specific dimension.

In accordance with an aspect, there is provided a method of separating one or more fractions from a sample. The method includes directing one or more mobile phases carrying a sample from an input/output valve to a first separation column. The method includes directing one or more fractions from the first separation column to a sampling valve. The sampling valve includes at least one fraction capturing device, e.g., a cartridge, configured to store at least one fraction of the one or more fractions per at least one fraction capturing device. The method further includes eluting the one or more fractions from the at least one fraction capturing device. The method includes directing each of the one or more eluted fractions to a second separation column. The method additionally includes separating one or more compounds within each of the one or more eluted fractions using the second separation column.

In some embodiments, the first separation column is associated with a first chromatographic separation system including SFC or HPLC. In some embodiments, the second separation column is associated with a second chromatographic separation system including SFC or HPLC. In a specific embodiment, the first chromatographic separation system includes SFC and the second chromatographic separation system include HPLC. In a particular embodiment, the first chromatographic separation system includes HPLC and the second chromatographic separation system includes SFC.

In accordance with an aspect, there is provided a method of retrofitting a two-dimensional chromatography system. The two-dimensional chromatography system to be retrofitted includes a first chromatographic separation system having a first separation column fluidly coupled to a second chromatographic separation system including a second separation column. The method includes fluidly coupling an input/output valve to a first switching valve of the first chromatographic separation system and a second switching valve of the second chromatographic separation system. The coupling of the input/output valve to the first switching valve and the second switching valve is performed such that one or more mobile phases can flow from the input/output valve to the first switching valve to the second switching valve. The method includes fluidly coupling a sampling valve between the first switching valve and the second switching valve. The sampling valve includes at least one fraction capturing device configured to collect one or more fractions of a sample passed through the first separation column.

### EXAMPLES

The function and advantages of these and other embodiments can be better understood from the following examples. These examples are intended to be illustrative in nature and are not considered to be in any way limiting the scope of the invention.

### Example—2-D Separation of Soy Lipid Extract

In this example, the separation of lipids in a soy lipid extract using the system illustrated in FIGS. 2 and 3 is explored. Here, the 2-D SFC/LC system incorporated SFC as the first dimension separation and UHPLC as the second dimension separation.

To start the first dimension separation, a soy lipid sample was injected into the first dimension separation column connected to the SFC valve. The flow of supercritical CO₂ from the first dimension separation column was directed to a sampling valve that included four C18 solid-phase extraction cartridges. The sampling valve was configured to switch between cartridges 1-4 to capture four different fractions from the first dimension separation column during heart cutting. When no heart cuts were being collected, the sampling valve was set to the bypass position. Heart cuts from the first dimension separation column directed to the first solid-phase extraction cartridge. Flow from the SFC was connected to a mass spectrometer via a splitter assembly on the input/output valve. Table 1 illustrates the solvent gradient composition and times used during the SFC separation for a total run time of 18 minutes.

TABLE 1
Timetable for Solvent Gradient in SFC Separation

| | Time | Supercritical | Methanol | Flow |
|---|---|---|---|---|
| Step | (min) | CO₂ (%) | (%) | (mL/min) |
| 1 | 1 | 95 | 5 | — |
| 2 | 5 | 70 | 30 | — |
| 3 | 15 | 50 | 50 | 0.7 |
| 4 | 16 | 50 | 50 | 0.7 |
| 5 | 16.1 | 95 | 5 | — |
| 6 | 18 | — | — | 0.7 |

The second dimension separation, UHPLC, was positioned in line with the solid phase extraction cartridges and the second dimension separation column. The elution of the captured fractions from the solid phase extraction cartridges to the dimension separation column was used for separating the components from heart cut fractions using HPLC. Table 2 illustrates the solvent gradient and times used during the HPLC separation. In Table 2, mobile phase A was 9:1 water:methanol and mobile phase B was 2:3:5 acetonitrile:methanol:isopropanol. The total run time was 18.1 minutes.

TABLE 2
Timetable for Solvent Gradient in UHPLC Separation

| | Time | Mobile | Mobile | Flow |
|---|---|---|---|---|
| Step | (min) | Phase A (%) | Phase B (%) | (mL/min) |
| 1 | 1 | 33 | 67 | — |
| 2 | 10 | 0 | 100 | — |
| 3 | 18 | 0 | 100 | — |
| 4 | 18.1 | 33 | 67 | — |

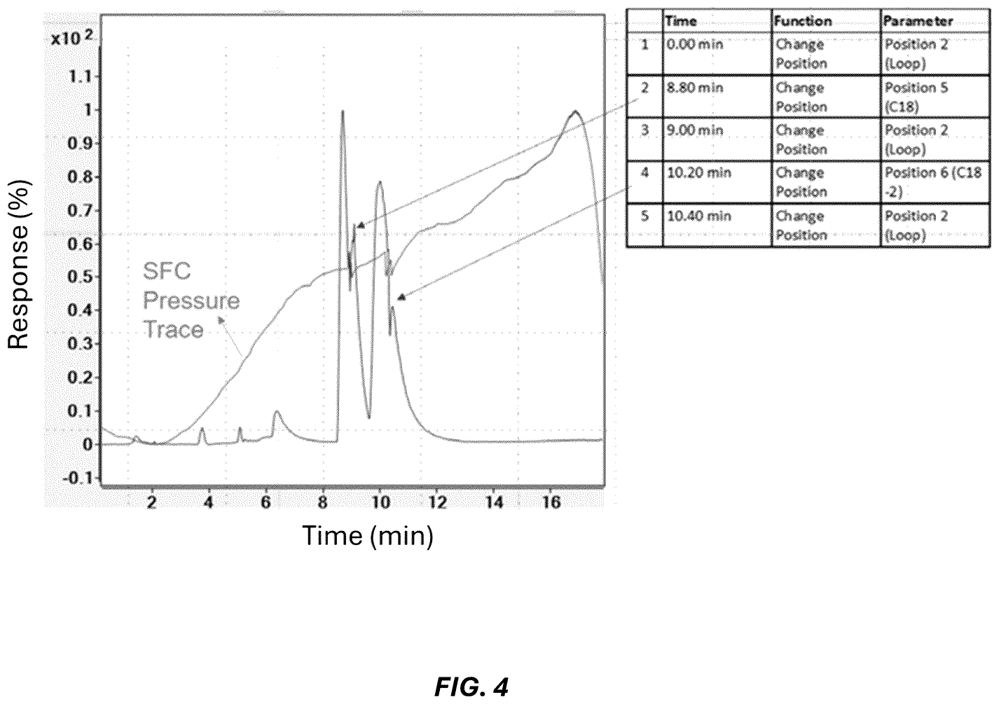

FIG. 4 illustrates the event table for the timed switching of the sampling valve. The two timed events at 8.8 minutes and 10.2 minutes were the times that the sampling valve switched from the bypass position to a position to let one of the solid phase extraction cartridges in line with the flow of the mobile phase for heart cutting. In FIG. 4, these timed events correspond to PC and LPC peaks, respectively, eluting from the first dimension separation column as shown with the arrows pointing to their respective peaks in the total ion chromatogram. In addition to the total ion chromatogram, FIG. 4 illustrates the SFC pressure trace superimposed. The SFC pressure trace illustrates a drop in pressure when the sampling valve switched from the bypass position to one of the C18 solid phase extraction cartridges. The drop in SFC pressure also corresponded to a drop in the total ion chromatogram due to a portion of the PC and LPC peaks being carried to a C18 solid phase extraction cartridge.

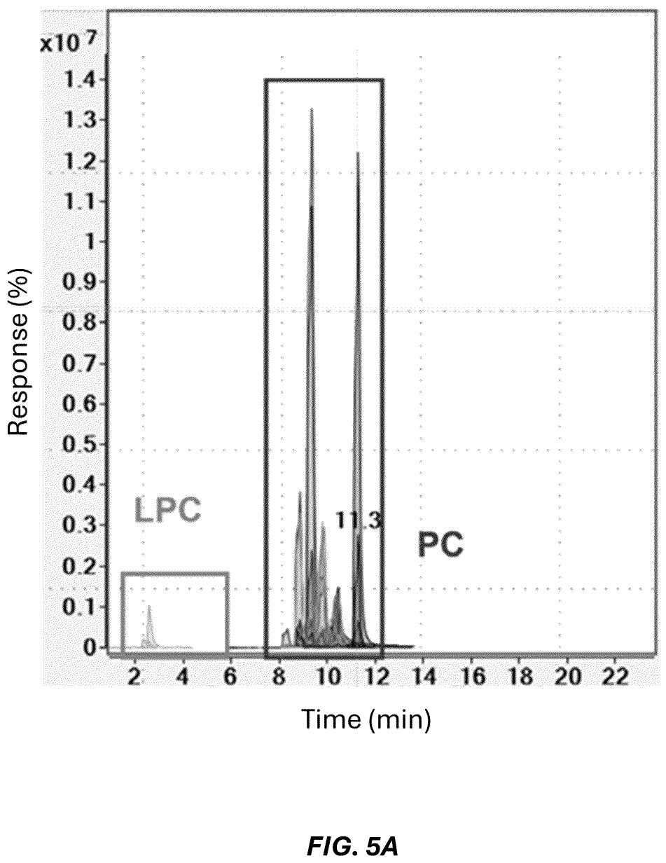

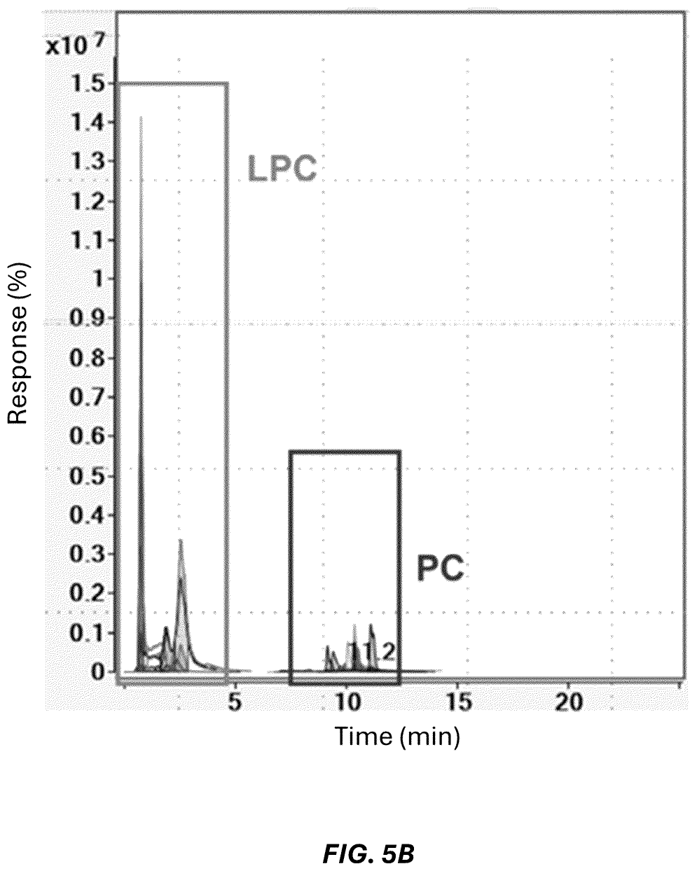

FIGS. 5A and 5B illustrate the lipid profile from the fractions captured and separated from the C18 solid phase extraction cartridges at 8.8 minutes and 10.2 minutes illustrated in FIG. 4. FIG. 5A corresponds to the lipid profile of the heart cut at 8.8 minutes and FIG. 5B corresponds to the lipid profile of the heart cut at 10.2 minutes. It is noted that with SFC separation in the first dimension, the elution order of lipids was orthogonal to the elution order obtained with UHPLC. As illustrated in FIG. 5A, the first heart cut at 8.8 minutes was substantially PC class lipids with a small fraction of LPC class lipids. Specifically, the first heart cut was 70 percent PC lipids, 15 percent LPC lipids, 10 percent PE lipids, and 5% PS lipids. In contrast, as illustrated in FIG. 5B, the second heart cut at 10.2 minutes was substantially LPC class lipids with a small fraction of PC class lipids, with the second heart cut having a breakdown of 62.5 percent LPC lipids and 37.5 percent PC lipids. Tables 3 and 4 illustrate the sum compositions of the heart cuts illustrated in FIGS. 5A and 5B, respectively.

TABLE 3
Lipid Composition for First Heart Cut

| Number | m/z | Formula | Class |
|---|---|---|---|
| 1 | 520.3401 | C₂₆H₅₀NO₇P | LPC |
| 2 | 522.3558 | C₂₆H₅₂NO₇P | LPC |
| 3 | 518.3247 | C₂₆H₄₈NO₇P | LPC |
| 4 | 790.6310 | C₄₄H₈₈NO₈P | PC |
| 5 | 778.5363 | C₄₄H₇₆NO₈P | PC |
| 6 | 788.6150 | C₄₄H₈₆NO₈P | PC |
| 7 | 760.5852 | C₄₂H₈₂NO₈P | PC |
| 8 | 780.5514 | C₄₄H₇₈NO₈P | PC |
| 9 | 790.6314 | C₄₄H₈₈NO₈P | PC |
| 10 | 756.5540 | C₄₂H₇₈NO₈P | PC |
| 11 | 786.6015 | C₄₄H₈₄NO₈P | PC |
| 12 | 784.5837 | C₄₄H₈₂NO₈P | PC |
| 13 | 758.5701 | C₄₂H₈₀NO₈P | PC |
| 14 | 780.5543 | C₄₄H₇₈NO₈P | PC |
| 15 | 782.5687 | C₄₄H₈₀NO₈P | PC |
| 16 | 778.5384 | C₄₄H₇₆NO₈P | PC |
| 17 | 818.6653 | C₄₆H₉₂NO₈P | PC |
| 18 | 716.5222 | C₃₉H₇₄NO₈P | PE |
| 19 | 740.5231 | C₄₁H₇₄NO₈P | PE |
| 20 | 790.5603 | C₄₂H₈₀NO₁₀P | PS |

TABLE 4
Lipid Composition for Second Heart Cut

| Number | m/z | Formula | Class |
|---|---|---|---|
| 1 | 522.3555 | C₂₆H₅₂NO₇P | LPC |
| 2 | 520.3399 | C₂₆H₅₀NO₇P | LPC |
| 3 | 522.3558 | C₂₆H₅₂NO₇P | LPC |
| 4 | 520.3402 | C₂₆H₅₀NO₇P | LPC |
| 5 | 496.3369 | C₂₄H₅₀NO₇P | LPC |
| 6 | 518.3246 | C₂₆H₄₈NO₇P | LPC |
| 7 | 522.3551 | C₂₆H₅₂NO₇P | LPC |
| 8 | 496.3400 | C₂₄H₅₀NO₇P | LPC |
| 9 | 520.3400 | C₂₆H₅₀NO₇P | LPC |
| 10 | 518.3238 | C₂₆H₄₈NO₇P | LPC |
| 11 | 790.6322 | C₄₄H₈₈NO₈P | PC |
| 12 | 782.5692 | C₄₄H₈₀NO₈P | PC |
| 13 | 758.5700 | C₄₂H₈₀NO₈P | PC |
| 14 | 784.5864 | C₄₄H₈₂NO₈P | PC |
| 15 | 780.5548 | C₄₄H₇₈NO₈P | PC |
| 16 | 786.6009 | C₄₄H₈₄NO₈P | PC |

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A two-dimensional chromatography system, comprising:
a first switching valve fluidly coupled to a first separation column;
a second switching valve coupled to a second separation column, the second switching valve being fluidly coupled to the first switching valve;
an input/output valve in fluid communication with the first switching valve and the second switching valve and configured to direct one or more mobile phases to the first switching valve; and
a sampling valve fluidly coupled to the first switching valve and comprising at least one fraction capturing device.

2. The two-dimensional chromatography system of claim 1, wherein the input/output valve is fluidly coupled to a downstream analytical instrument.

3. The two-dimensional chromatography system of claim 1, wherein the first switching valve is configured to direct the one or more mobile phases to the sampling valve without passing through the first separation column.

4. The two-dimensional chromatography system of claim 1, wherein the input/output valve is configured to direct the one or more mobile phases to a sampler device storing a sample.

5. The two-dimensional chromatography system of claim 4, wherein the first switching valve is configured to direct the one or more mobile phases having the sample through the first separation column.

6. The two-dimensional chromatography system of claim 5, wherein the first switching valve is configured to direct fractions from the first separation column as one or more heartcuts to the sampling valve, the sampling valve disposed to store the one or more heartcuts on the at least one fraction capturing device.

7. The two-dimensional chromatography system of claim 6, wherein the sampling valve is further configured to direct at least one mobile phase from the input/output valve to elute the one or more heartcuts from the at least one fraction capturing device.

8. The two-dimensional chromatography system of claim 7, wherein the sampling valve is further configured to direct the elutions of the one or more heartcuts from the at least one fraction capturing device to the second switching valve.

9. The two-dimensional chromatography system of claim 8, wherein the second switching valve is configured to direct the elutions of the one or more heartcuts from the at least one fraction capturing device to the second separation column.

10. The two-dimensional chromatography system of claim 9, wherein the second switching valve is configured to direct fractions from the second separation column to the input/output valve.

11. The two-dimensional chromatography system of claim 8, wherein the second switching valve is configured to direct the elutions of the one or more heartcuts from the at least one cartridge to the input/output valve.

12. The two-dimensional chromatography system of claim 1, wherein the sampling valve is further configured to bypass the at least one fraction capturing device.

13. The two-dimensional chromatography system of claim 1, wherein the first switching valve is associated with a first chromatographic separation system comprising supercritical fluid chromatography (SFC).

14. The two-dimensional chromatography system of claim 1, wherein the second switching valve is associated with a second chromatographic separation system comprising high pressure liquid chromatography (HPLC).

15. The two-dimensional chromatography system of claim 1, wherein the first switching valve is associated with a first chromatographic separation system comprising HPLC.

16. The two-dimensional chromatography system of claim 1, wherein the second switching valve is associated with a second chromatographic separation system comprising SFC.

17. A method of separating one or more fractions from a sample, comprising:
directing one or more mobile phases carrying a sample from an input/output valve to a first separation column;
directing one or more fractions from the first separation column to a sampling valve, the sampling valve comprising at least one fraction capturing device configured to store at least one fraction of the one or more fractions per at least one fraction capturing device;
eluting the one or more fractions from the at least one fraction capturing device;
directing each of the one or more eluted fractions to a second separation column; and
separating one or more compounds within each of the one or more eluted fractions using the second separation column.

18. The method of claim 17, wherein the first separation column is associated with a first chromatographic separation system comprising SFC or HPLC.

19. The method of claim 17, wherein the second separation column is associated with a second chromatographic separation system comprising SFC or HPLC.

20. A method of retrofitting a two-dimensional chromatography system comprising a first chromatographic separation system comprising a first separation column that is fluidly coupled to a second chromatographic separation system comprising a second separation column, the method comprising:
fluidly coupling an input/output valve to a first switching valve of the first chromatographic separation system and a second switching valve of the second chromatographic separation system such that one or more mobile phases can flow from the input/output valve to the first switching valve to the second switching valve;
fluidly coupling a sampling valve between the first switching valve and the second switching valve, the sampling valve comprising at least one fraction capturing device configured to collect one or more fractions of a sample passed through the first separation column.
